(19) United States
(12) Patent Application Publication
(10) Pub. No.: US 2023/0206222 A1
(43) Pub. Date: Jun. 29, 2023

(54) HARDWARE WALLET FOR CRYPTOCURRENCY

(71) Applicant: Mikhail Y. KIRILLOV, Podolsk Moscow Obl. (RU)

(72) Inventor: Mikhail Y. KIRILLOV, Podolsk Moscow Obl. (RU)

(21) Appl. No.: 17/613,035

(22) PCT Filed: Dec. 10, 2019
(86) PCT No.: PCT/RU2019/000922

§ 371 Date: Nov. 19, 2021

(30) Foreign Application Priority Data
Apr. 1, 2019 (RU) 2019109559

(51) Int. Cl. G06Q 20/36; G06Q 20/32; G06Q 20/40; G06F 21/86

(52) U.S. Cl. CPC G06Q 20/3678; G06Q 20/3278; G06Q 20/40145; G06F 21/86; G06Q 2220/00

(57) ABSTRACT

The invention relates to hardware and software for data storage and consummation of digital transactions in peer-to-peer environments, primarily for making cryptocurrency payments. The technical result consists in higher security for using a hardware wallet. 3 sub-claims.

### RELATED APPLICATIONS

This Application is a U.S. National Stage Under 35 USC §371 of International Application PCT/RU2019/000922, filed on Dec. 10, 2019, which in turn claims priority to Russian Patent Application RU2019109559, filed Apr. 1, 2019, both of which are incorporated herein by reference in their entirety.

### FIELD OF THE INVENTION

The claimed invention relates to the field of electronic payment systems. More specifically, the invention relates to the hardware and software tools for data storage and consummation of digital transactions in a peer-to-peer environment.

### BACKGROUND OF THE INVENTION

At the modern development stage of electronic payment services, an individual place is taken by the services based on the use of the so-called cryptocurrencies. The payment systems based on cryptographic elements enable any participants to transfer funds directly, without involving an intermediary.

The Bitcoin unit used by a peer-to-peer payment system of the same name can be viewed the best known (and the earliest) cryptocurrency. The use of cryptocurrencies gives an advantage which consists in complete system decentralization, with the system having no administering authority (or tool) possessing a regulatory function for user-to-user transfer of funds. Network users are combined into a peer network through a client program, i.e. every node (user) of that network has equal opportunities. The cryptocurrency value is ensured by the total number of “coins” which can be “issued” within each payment system being limited as well as by the computing resources which are necessary for the so-called mining, i.e. the issuance of new coins within a network for such issuance essentially represents the solution of a complex (even for state-of-the-art electronic equipment) mathematical problem. To offset the growing computation power and fluctuating number of the nodes working in the network, the hashing complexity changes automatically to ensure that the block generation rate be uniform. If they appear too frequently, the complexity increases and vice versa.

It is customary to designate as the first publicly available description of the Bitcoin cryptocurrency system the file “Bitcoin A Peer-to-Peer Electronic Cash System” (refer to https://bitcoin.org/bitcoin.pdf) published in the Internet in 2008 which describes both the general idea of a peer payment network and the interaction protocols enabling mining and user-to-user transfer of funds to be carried out (with such actions referred to by convention as transactions).

The said document defines an electronic coin as a sequence of digital signatures. A regular owner sends a coin to the next one by signing the hash of the previous transaction and the future owner's public key and by attaching that information to the coin. The recipient may verify each signature to confirm that the entire chain of owners is correct. The blocks generated by the network which include all information on both the coins generated and their owners as well as on all network transactions conducted are included in a successive chain of blocks, the so-called Blockchain, provided that such data is confirmed by the network participants (nodes) which ensures self-regulation of such systems.

Transaction verification is possible without launching a fully functioning node. A user only needs to keep the headings of the blocks in the longest chain which s/he has received from the other nodes and to request a hash sub-tree for the required transaction. S/he is unable to verify transaction correctness independently but, having received a link to the block accommodating it, s/he can make sure that the said block and all the subsequent blocks have been accepted and confirmed by the network.

The following algorithm represents in simplified form how the system works:
new transactions are sent to all nodes;
each node combines incoming transactions into a block;
each node attempts to select a block hash that complies with the current complexity;
once such hash has been found, that block is sent into the network;
the nodes only accept the block if all the transactions in it are correct and do not use the funds that have already been spent; and
the nodes express their consent to the new data by beginning work on the next block and by using the hash of the previous block as new input data.

Any other known cryptocurrency systems are based on using a similar network in terms of essential structure, with the main difference consisting in the use of cryptographic processing algorithms (for example: SHA-256, Scrypt, Ethash, X11, CryptoNight, etc.).

The known systems generally use pairs—an open key and a closed (private) key—to create wallet addresses and to confirm that transaction formation is eligible. The client program keeps the keys created in a file placed on a hard disk (normally, wallet.dat). The loss of that file signifies the loss of the wallet funds (by way of analogy, refer to the loss of a wallet with fiat funds). At the same time, a new key cannot be created for an existing address since a unique pair of keys always has its own corresponding address and the system is based on the application of one-sided functions, i.e. such f (x) functions for which the f (x) value can be easily found if x is known, whereas determination of x from f (x) is impossible over a reasonable period of time. The funds related to the address for which there is no private key become unavailable, i.e. get lost.

Any third-party access to the data in the said file (for example: through a virus attack) means losing control over the funds contained in the wallet since any person possessing private key data is able to make a transaction and transfer funds to any address, with such transfer being anonymous. The encryption tools contemplated for a wallet.dat file cannot be recognized as objectively increasing security because the file encryption decision, just like the assignment of the password itself, is made by the user independently, with password decryption taking incomparably less time than determination of x from the f (x) one-sided function.

Private key data can be stored in the so-called “hot” wallets (for example: various online services) as well as in “cold” vaults (for example: a flash drive which is not connected to a computer and on which a wallet.dat file is recorded).

Keeping in a “hot” wallet appears to be unsafe since the funds can be stolen by online service employees or seized by any third-party organizations (remarkably exemplified by the closure of the MtGox, CoinCheck, BTC-E, and WEX cryptocurrency exchanges with the users losing control over their deposited funds). In 2018, a total of 1.8 billion U.S. dollars worth of cryptocurrency was stolen.

Data placement in a “cold” wallet appears to be safe in most circumstances. However, such placement is not convenient for making transactions in the sense that the users of plastic cards or fiat money are accustomed to. At the same time, it is only sufficient to have the open and closed key data to make transactions resulting in the prior art creation of the so-called hardware wallets allowing payment for goods and services to be made without binding to any desktop computers (for example: the Trezor wallet).

A known hardware wallet features a hardware and software tool accommodated within an enclosure with control elements and functions under software control. At the same time, the known hardware wallet is designed such that it does not appear possible to use any other unapproved software. In particular, when the device is switched on, the loading program located in a write-protected memory area checks the operating system's signatures and issues a warning if any mismatch condition is found. When updating the software, the loading program clears the memory and only installs the update if the software signature meets the requirements being checked.

However, the known solution has a significant drawback which consists in the following.

The use of the known hardware wallet assumes that the user will interact with it in the same way as with any other known means of payment. Specifically, payment for goods and services contemplates that the user physically has a hardware wallet at the time of payment. Consequently, a loss or forcible take-over of such hardware wallet may take place in the same manner as when fiat money or plastic cards are used.

The wallet manufacturer itself indicates that there are software vulnerabilities consisting particularly in data leakage from the random access memory (refer, for example, to https://blog.trezor.io/details-about-the-security-updates-in-trezor-one-firmware-1-7-2-3c97adbf121e). Thus, the reliable utilization of the known wallet requires continuous monitoring for the existence of software updates. At the same time, the person who has taken possession of the wallet in any way has enough time to physically impact the hardware wallet for the purpose of reading the data which directly or indirectly pertains to the private key data, for example: by connecting directly to the pins of the memory, microprocessor, etc. In addition, such person may wait until data has been published pertaining to new program vulnerabilities and deliver an attack to read the said data without updating the device. The known solution has no countermeasures to offer against the attacks of the said type; in particular, it has no information protection capability in case the device enclosure has been opened up. The manufacturer only notes that the device enclosure has been ultrasonically welded which makes it difficult to restore the enclosure after it has been opened up. However, no data protection facilities have been stated by the manufacturer for enclosure opening.

Thus, the background of the invention claimed is the need to create a tool suitable for making transactions amid an expanding infrastructure of cryptocurrency payments and possessing a strong security level showing itself, among other things, when the hardware wallet is lost, which constitutes a technical result of the invention claimed.

### SUMMARY OF THE INVENTION

To achieve the said technical result, a hardware wallet for cryptocurrency is offered containing an enclosure which accommodates: a display, a battery connected to a combined antenna intended for the wireless charging of the battery and for NFC data exchange, a charging controller connected to the battery, as well as a hardware security module which is connected to the display, the battery, and the combined antenna and which represents a secure crypto processor based on a system on a chip (SoC) and integrating a CPU, an input/output interface, an encryption box, EEPROM (Erasable Programmable Read-only Memory), RAM, Bluetooth, and an NFC controller, with the hardware module designed to store cryptocurrency-related information in a secure EEPROM area and the enclosure capable of accommodating physical control elements for hardware wallet control.

In additional embodiments, the hardware security module is designed with it being possible to clear the private keys in the memory when it is taken out of the enclosure The physical control element may be designed as a button to confirm transactions, which is combined with a finger print scanner and connected to the hardware security module.

### DETAILED DESCRIPTION OF THE PREFERRED EMBODIMENTS

The description below provides information on how the invention claimed can be embodied by using the tools and methods known in the prior art.

It should be noted that the information on the preferred invention embodiments provided in the description is illustrative and is not intended to limit the scope of legal protection for the invention claimed. A specialist will understand that the information on the tools and methods which is not included in the description may be included within the the scope of protection for the invention in accordance with its functional area.

A detailed description of the architecture and algorithms of the functioning of cryptocurrency payment systems falls outside the scope of this application because they are widely known by themselves, and the stated technical solution represents but an interface for the end user.

The prior art analysis revealed information on the so-called secure crypto processors being known. Unlike cryptographic processors “trusting” the bus and outputting unencrypted data to it as if it were located in a secure environment, a secure crypto processor does not output unencrypted data or unencrypted program instructions into an environment which cannot always be reliably secure. The term “secure crypto processor” has not been introduced by the applicant for the first time, and and it is known to have been used in the prior art before the priority date of the invention claimed.

In particular, specifications of such secure crypto processors are known (refer, for example, to Trusted Computing Group, Incorporated; TPM Main Part 2. TPM Structures. Specification version 1.2. Level 2 Revision 116, 01.03.2011), which reveal their internal structure and functioning algorithms

For example, when executed in the form of a system on a chip (SoC), a secure crypto processor receives input program instructions in encrypted form, decrypts them, and executes them within the same microchip where decrypted instructions are stored. Information on the possible interaction of a microprocessor and any other data encryption circuit elements is set forth, for example, in R. Elbaz and others, Hardware Engines for Bus Encryption: a Survey of Existing Techniques, 2005.

Consequently, there are prerequisites in place for the existence of a cause-and-effect relationship between the utilization of a secure crypto processor in the solutions vulnerable to external actions and increasing their security in use. As shown above, a hardware wallet for cryptocurrency is critically vulnerable to an external action where any unknown persons take possession of it. Therefore, it is a secure crypto processor that the invention claimed suggests using as a hardware security module.

It will be fairly easy for a specialist to implement the internal structure of a secure crypto processor in the form of a SoC. For example, a crypto processor implementing bus-based information processing in encrypted form is known from the patent document U.S. Pat. No. 4,278,837 A, 14 Jul. 1981 (claim 1, FIG. 1).

Thus, the inclusion of a crypto processor in the solution claimed allows the security of using a hardware wallet for cryptocurrency to be considerably increased in the sense understood by this application, i.e. the inclusion in the claims of an attribute characterizing the particular use of a crypto processor is essential to the possibility of achieving the said technical result.

At the same time, the fact of the said architectural solutions being known enables a specialist to integrate a CPU, input/output interfaces, an encryption module, EEPROM (Erasable Programmable Read-only Memory), RAM, Bluetooth, and an NFC controller into a SoC to assign to it the functions of a hardware security module used in the technical solution claimed.

There is no information discovered in the prior art on any tools having the same purpose as the device claimed, wherein it would be suggested using a secure crypto processor as a hardware security module.

In addition, since the tool claimed is proposed to be used in a specific environment of working with cryptocurrency payment systems (as reflected in the generic concept of the claims), the essential inventive features should include those characterizing the possibility of storing the cryptocurrency-related information in a protected memory area as well as the possibility of signing a transaction because it does not appear possible to implement the designated purpose of the device claimed without doing so.

The use of a secure crypto processor makes it significantly more difficult for an evil-doer to obtain the data which would allow an illegal transaction to be conducted subsequently because data is processed within a chip (SoC), with information transfer taking place in encrypted form.

As a memory intended for the storage of cryptocurrency-related information, it is expedient to use EEPROM (Erasable Programmable Read-only Memory). Cryptocurrency keys are normally viewed as the said information, which are placed in a protected memory area for the invention claimed.

In a preferred embodiment, it is suggested that the device claimed be executed in the form of a light rugged enclosure (for example, made of polycarbonate) housing all the main device assemblies. The enclosure may also accommodate a display and physical control elements for wallet operation. The enclosure may be designed moisture proof according to the relevant standard (for example, IP57). The display may be executed as a monochrome or color display and may be touch-screen type.

The physical control elements may be represented by an on/off button, a button to confirm transactions, a finger print scanner, and navigation elements for the user interface sections displayed on the screen. In some embodiments, the button to confirm transactions may be combined with the finger print scanner for higher security of the device claimed.

Since the invention claimed is taken to be used within the present-day infrastructure, it is preferable to ensure wireless data transfer capability implemented, for example, by using an NFC module, which allows making use of the invention in a similar way to known payment solutions such as Apple Pay, Samsung Pay, etc. To keep the device compact, it is proposed to use a combined antenna intended for the wireless charging of the enclosure-housed battery and for NFC data exchange when conducting transactions. In an additional embodiment, the device claimed may include a camera and a relevant processing module allowing transactions to be conducted by optical payment terminals reading QR code information (in and of itself, such processing is widely known and used, for example, for payments made by using mobile telephones; therefore, no detailed description of the tools and their interaction algorithms is required for a specialist). The device may be executed with two-factor authorization support based on the FIDO U2F protocol. The device may support data transfer by using the Bluetooth wireless interface.

The device may be set up by using a prior art known method, and a detailed description of such set-up falls outside the scope of the invention claimed. For example, the device is connected to a computer through an appropriate port (preferably, USB). Once it has been energized, the device launches a secure loading program which may reside in a protected memory area. The secure loading program checks the signatures of the software which controls the device claimed and forbids device operation in case of mismatched signatures. The software may be configured to support the programmed cryptocurrency wallets residing on the PC by using a prior art known method. Access to the device is set by selecting a PIN code or setting up the finger print scanner. Support for a specific cryptocurrency can be ensured by loading the relevant secure software when connection to the PC is established. The transaction recipient and the required amount can be selected by using the control elements on the enclosure, in the PC software wallet, or by reading a QR code. A transaction is confirmed by pressing the relevant button on the device enclosure. The combination of the transaction confirmation button and the finger print scanner materially increases the security of the transaction being conducted. The device may be additionally outfitted with a Bluetooth interface which can be used, for example, to implement two-factor authorization for a mobile telephone application when conducting transactions.

In addition, for higher security in using the invention, the hardware security module is configured for clearing the cryptocurrency-related information in the memory (or all information contained in the memory) if any unauthorized access attempts are detected.

The practical feasibility of such solution is known from the prior art before the priority date of the invention (refer, for example, to application US 2012185636 A1 dated Jul. 19, 2012). In a known solution, the protection module comparing the electrical characteristics of a circuit (resistance, capacitance, inductance) with predetermined values resolves to clear the memory-contained information. In the solution claimed, the application of such tool (integrated into the hardware security module or located individually, with its own power supply) may detect attempts to connect external devices to the crypto processor chip pins with subsequent clearance of the private information from the memory. The device intrusion protection module may be provided with an additional power supply source for backup power supply to the emergency memory clearance circuit.

In addition, the prior art also knows a solution which allows an electronic device to thermally self-destruct in case of attempted unauthorized access (refer to patent U.S. 9,812,407 B2 dated Nov. 7, 2017). Also known are Cypress self-destructing memory chips (https://www.cypress.com/file/99056/download).

In the solution claimed, the destruction trigger (tool) may operate in a variety of ways. The following can be used as a device penetration sensor: a tie breaker, a balanced magnetic switch, a pressure sensor, a light sensor (for various ranges), and a radio wave sensor. The intrusion protection circuit may be configured as an individual unit which disintegrates when exposed to atmospheric pressure (with vacuum created within the device enclosure in advance) or air oxygen. The mechanical control (protection) tools for penetration into the enclosure may be placed in locations which are not known to users in advance (for example, the enclosure may contemplate a number of such locations, with the device only placed in one of them chosen randomly during manufacture or the enclosure may be designed such that the tool is initially placed in random order during manufacturer and operates when the enclosure is opened). Such placement ensures that an evil-doer does not know in advance where exactly the protection tool is located and is unable to take measures to bypass it. Thus, the solution claimed may be furnished with two protection levels: from penetration into the device and from penetration into the combined chip, which significantly increases security in using the invention as disclosed in this description.

In view of numerous exemplary embodiments of the features of the invention claimed as listed above, it is reasonable to assume that the essential features of the claims may be summarized collectively to the extent to which they have been presented therein, without losing their effect on the possible implementation of the purpose of the invention and on the achievement of the said technical result.

1. A hardware wallet for cryptocurrency comprising:
an enclosure comprising:
a display;
a battery connected to a combined antenna for wireless charging of the battery and for exchanging NFC data;
a charging controller connected to the battery; and
a hardware security module;
the hardware security module being connected to the display, to the battery, and to the combined antenna and being a secure crypto processor based on a system on a chip (SoC) and integrating a CPU, an input/output interface, an encryption box, EEPROM (Erasable Programmable Read-only Memory), RAM, Bluetooth, and an NFC controller;
wherein the hardware security module is adapted to store cryptocurrency-related information in a secure EEPROM area and wherein the enclosure is adapted to accommodate physical control elements for controlling the hardware wallet.

2. The hardware wallet according to claim 1, wherein the hardware security module is further adapted to clearing the cryptocurrency-related information in the memory.

3. The hardware wallet according to claim 2, further comprising a protection module connected to the hardware security module, the protection module being adapted to detecting penetration into the enclosure or the SoC, wherein the clearing of the cryptocurrency-related information occurs in response to the penetration.

4. The hardware wallet according to claim 1, further comprising a physical control element being a button combined with a finger print scanner and connected to the hardware security module, the button serving to confirm transactions.

5. The hardware wallet according to claim 2, further comprising a physical control element being a button combined with a finger print scanner and connected to the hardware security module, the button serving to confirm transactions.

6. The hardware wallet according to claim 3, further comprising a physical control element being a button combined with a finger print scanner and connected to the hardware security module, the button serving to confirm transactions.
